(19) United States
(12) Patent Application Publication
(10) Pub. No.: US 2007/0242286 A1
(43) Pub. Date: Oct. 18, 2007

(54) Method and system for printing personal management information

(75) Inventor: Nam Heo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/709,736

(22) Filed: Feb. 23, 2007

Related U.S. Application Data
(60) Provisional application No. 60/791,420, filed on Apr. 13, 2006.

(30) Foreign Application Priority Data
May 12, 2006 (KR) 2006-43138

(51) Int. Cl. G06F 15/00

(52) U.S. Cl. 358/1.6

(57) ABSTRACT

A method and system for printing personal management information is provided with creating extensible hyper text markup language (XHTML)-data of the personal management information using an XHTML-template defining a layout for printing the personal management information and transmitting the created XHTML-data to an image forming device, and analyzing the transmitted XHTML-data and printing the personal management information. As a result, a user can easily edit and print the personal management information using a markup language, such as XHTML-data, in order to designate a style.

### CROSS-REFERENCE TO RELATED APPLICATIONS

This application claims all benefits accruing under 35 U.S.C. §120 from U.S. Provisional Patent Application No. 60/791,420, filed on Apr. 13, 2006, in the US Patent and Trademark Office, and all benefits accruing under 35 U.S.C. §119 from Korean Patent Application No. 2006-43138, filed on May 12, 2006, in the Korean Intellectual Property Office, the disclosures of which are incorporated herein by reference.

### BACKGROUND OF THE INVENTION

1. Field of the Invention

The present invention relates to a method of providing a printout in an image forming device using an electronic device such as a mobile device, and more particularly, to a method and system for printing personal management information using a markup language, such as extensible hyper text markup language (XHTML)-Print data, in order to designate a style.

2. Related Art

As mobile devices, such as mobile phones, have become widely accepted and commonly used to capture, store and/or send digital images, and as image resolutions of those mobile devices continues to improve in ways that are similar to digital still cameras, consumers have come to expect the imaging and printing industry to deliver mobile printing solutions that are simple and reliable for printing at home. For example, a user will want to print a photo from a mobile device, such as a mobile phone, in a simple format using a mobile device such as a cellular phone. However, only photographs having a simple format have been required when a user prints captured photographs using a mobile device such as a cellular phone. Recently, owing to the development of mobile device technology, content, such as extensible hyper text markup language (XHTML)-Print data, for defining layouts having various formats and various kinds of information, has been provided.

The Mobile Imaging and Printing Consortium (MIPC)), which is a neutral, non-profit organization that drives mobile printing guidelines across the hardware, software and wireless industries, has been discussing various technologies for using such a function between a mobile device, such as a mobile phone, and an image forming device, such as a printer. The functions of the mobile device and the printer can become complex, since these device must address limitations in terms of power of a CPU and various hardware/software resources. For example, the mobile device must have a certain minimum processing power, and the printer must have more processing power than the mobile device. Here, a problem occurs, in that the CPU power and various hardware/software resources are limited, compared to the complexity of functions required by these devices. To solve this problem, a trend has developed in which the mobile device is allowed to perform only the minor portion of the functions with the least number of components and the printer is allowed to perform the major portion of the functions.

In particular, a host computer, such as a desktop or laptop computer, can output personal management information using a specific application and provide a visual display of the personal management information on a screen. Such personal management information may indicate information related to a personal daily life of a user, such as, a schedule chart, an address book, a to-do list, and so on. For example, to create a schedule chart, the user inputs personal schedules on relevant dates and selects a range (e.g., weekly, monthly, etc.) of the schedules to be printed using a specific application, and then a schedule chart corresponding to the selected range is created and displayed on a screen. If the user requests a printout by selecting an option in a print menu of the application to print the displayed schedule chart, schedule data is converted to printer description language (PDL) data by a printer driver installed in the host computer, the converted data is transmitted to an image forming device such as a printer, so that the printer can print the schedule chart using an emulator and a print engine.

However, when a schedule chart is created using a specific application to the host computer, personal management information according to a pattern desired by a user cannot be output. This limitation is larger in electronic or mobile devices having more limited hardware/software capability than a host computer such as a desktop or laptop computer. In addition, since a typical electronic or mobile device has a low system specification, such a device cannot include a printer driver provided by a printer. Moreover, even if a printer driver can be installed in an electronic or mobile device, such a printer driver depends on a specific type of printer. As a result, if a different type of a printer is used, such personal management information according to a pattern desired by a user still cannot be printed. However, such an electronic device or mobile device cannot realistically include various types of printer drivers.

### SUMMARY OF THE INVENTION

Several aspects and example embodiments of the present invention provide a method and system for printing personal management information to allow a user to easily print personal management information using a markup language, such as extensible hyper text markup language (XHTML)-data, for designating a style.

Additional aspects and/or advantages of the invention will be set forth in part in the description which follows and, in part, will be obvious from the description, or may be learned by practice of the invention.

In accordance with an example embodiment of the present invention, there is provided a method of printing personal management information. Such a method comprises: creating, at a mobile device, XHTML-data of the personal management information using an XHTML-template defining a layout for printing the personal management information and transmitting the created XHTML-data to an image forming device, via a transmission link; and analyzing, at the image forming device, the transmitted XHTML-data and printing the personal management information.

According to an aspect of the present invention, such a method further comprises receiving setting information of the personal management information; and selecting an XHTML-template corresponding to the received setting information and creating XHTML-data on which the received setting information is reflected before transmitting the created XHTML-data to the image forming device, via a transmission link.

According to an aspect of the present invention, the personal management information comprises at least one of schedule information, address book information, to-do list information, and name card information. The schedule information may comprise date information, identification information according to priority assignment, and schedule description input by a user. The identification information may comprise at least one of color, font type, font size, shadow, and underline.

According to an aspect of the present invention, such a method further comprises selecting the schedule information among the personal management information; determining whether general priority assignment is selected in the selected schedule information; when the general priority assignment has been selected, determining whether establishment of new identification information according to the general priority assignment is required; when establishment of new identification information is required, setting new identification information according to the general priority assignment; and storing the selected and set information as setting information of the personal management information.

According to another aspect of the present invention, such a method further comprises selecting the schedule information among the personal management information; determining whether item-based priority assignment is selected from the selected schedule information; when the item-based priority assignment has been selected, selecting a specific item according to item-based priority; determining whether establishment of new identification information according to the item-based priority assignment is required; when establishment of new identification information is required, setting new identification information according to the item-based priority assignment; and storing the selected and set information as setting information of the personal management information.

According to an aspect of the present invention, the address book information may comprise field-based identification information of an address book, record-based identification information of the address book, and field and record-based identification information of the address book, wherein the field-based identification information of the address book, the record-based identification information of the address book, and the field and record-based identification information of the address book comprise at least one of color, font type, font size, shadow, and underline.

According to another aspect of the present invention, such a method further comprises selecting the address book information among the personal management information; determining whether field-based establishment is selected from the selected address book information; when the field-based establishment has been selected, selecting a specific field; determining whether establishment of new identification information according to the specific field is required; when establishment of new identification information is required, setting identification information of the specific field; and storing the selected and set information as setting information of the personal management information.

According to another aspect of the present invention, such a method further comprises selecting the address book information among the personal management information; determining whether record-based establishment is selected from the selected address book information; when the record-based establishment has been selected, selecting a specific record; determining whether establishment of new identification information according to the specific record is required; when establishment of new identification information is required, setting identification information of the specific record; and storing the selected and set information as setting information of the personal management information.

According to an aspect of the present invention, the XHTML-data is created to print the personal management information into which an image is inserted or to print the image with name card information.

In accordance with another example embodiment of the present invention, there is provided a system for printing personal management information, comprising: an electronic device arranged to create XHTML-data of the personal management information using an XHTML-template defining a layout for printing the personal management information, and to transmit the XHTML-data, via a transmission link; and an image forming device arranged to receive the XHTML-data transmitted from the electronic device, via the transmission link, and to print the personal management information.

According to an aspect of the present invention, such an electronic device comprises: an XHTML-template information storage unit to store XHTML-template information corresponding to various layouts of the personal management information; a user interface unit arranged to enable a user to input setting information of the personal management information; a setting information storage unit to store the setting information input by the user; an XHTML-data creator arranged to detect an XHTML-template corresponding to the stored setting information and to create XHTML-data on which the input setting information is reflected; and a data transmitter arranged to transmit the created XHTML-data to the image forming device, via a transmission link.

According to a further aspect of the present invention, such an electronic device further comprises an insertion image storage unit arranged to store various images to be inserted into the personal management information, wherein the XHTML-data creator creates the XHTML-data to print the personal management information into which an image stored in the insertion image storage unit is inserted.

According to a further aspect of the present invention, such an image forming device comprises an interpreter arrange to analyze the XHTML-data transmitted from the electronic device; and a print engine arranged to print the analyzed XHTML-data.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a flowchart illustrating a method of printing personal management information according to an example embodiment of the present invention;

FIG. 2 is a flowchart illustrating a process of creating extensible hyper text markup language (XHTML)-Print data of the personal management information and transmitting the created XHTML-Print data to an image forming device according to an example embodiment of the present invention;

FIG. 3 is a flowchart illustrating a process of receiving setting information of personal management information according to an example embodiment of the present invention;

FIG. 4 is a flowchart illustrating a process of receiving setting information of personal management information according to another example embodiment of the present invention;

FIG. 5 is a flowchart illustrating a process of receiving setting information of personal management information according to another example embodiment of the present invention;

FIG. 6 is a flowchart illustrating a process of receiving setting information of personal management information according to another example embodiment of the present invention;

FIG. 7 illustrates a dialog box for printing personal management information according to an example embodiment of the present invention;

FIGS. 8A through 8C illustrate dialog boxes for setting schedule information according to an example embodiment of the present invention;

FIGS. 9A through 9D illustrate dialog boxes for setting schedule information according to another example embodiment of the present invention;

FIGS. 10A through 10C illustrate dialog boxes for address book information according to an example embodiment of the present invention;

FIGS. 11A and 11B illustrate dialog boxes for address book information according to another example embodiment of the present invention;

FIGS. 12A through 12C illustrate XHTML-Print data created using detected XHTML-Print templates and a printed result thereof according to an example embodiment of the present invention;

FIGS. 13A through 13C illustrate XHTML-Print data created using detected XHTML-Print templates and a printed result thereof according to another example embodiment of the present invention;

FIGS. 14A through 14C illustrate XHTML-Print data created using detected XHTML-Print templates and a printed result thereof according to another example embodiment of the present invention;

FIG. 15 illustrates personal management information printed by analyzing XHTML-Print data according to another example embodiment of the present invention;

FIG. 16 illustrates personal management information printed by analyzing XHTML-Print data according to another example embodiment of the present invention;

FIGS. 17A through 17C illustrate XHTML-Print data created using detected XHTML-Print templates and a printed result thereof according to another example embodiment of the present invention; and

FIG. 18 is a block diagram of a system for printing personal management information using a device according to an example embodiment of the present invention.

### DETAILED DESCRIPTION OF THE EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

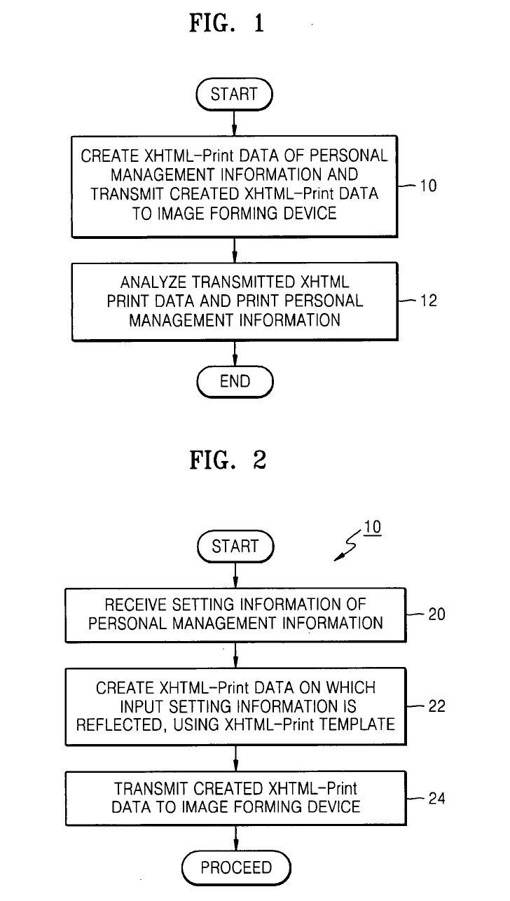

FIG. 1 is a flowchart illustrating a method of printing personal management information according to an example embodiment of the present invention. According to example embodiments of the present invention, an electronic device or a mobile device may correspond to a mobile phone, a personal digital assistant (PDA), or a portable device. An image forming device may correspond to a compact photo-printer or an image printer.

Referring to FIG. 1, an XHTML-Print template providing a layout is used at a mobile device to generate extensible hyper text markup language (XHTML)-Print data of personal management information, and transmit the generated XHTML-Print data to an image forming device, such as a printer, at block 10. In other words, the XHTML-Print data is created using an XHTML-Print template defining a layout for printing the personal management information, and the created XHTML-Print data is transmitted to an image forming device. Upon receipt of the transmitted XHTML-Print data, the image forming device analyzes the received XHTML-Print data and prints the personal management information at block 12.

FIG. 2 is a flowchart of an example transmission of XHTML-Print data at block 10, shown in FIG. 1. Referring to FIG. 2, setting information of the personal management information is received at block 20. The personal management information includes at least one of schedule information, address book information, to-do list information, and name card information. The schedule information may be displayed using a chart to easily check schedules of a user's daily life. The address book information may indicate information on individual addresses and telephone numbers, and the to-do list information may indicate information on descriptions and dates of personal things to do. However, the schedule information, the address book information, and the to-do list information are only example illustrations of the personal management information. Different types of personal management information can also be defined. XHTML-Print data on which input setting information is reflected, is created using the XHTML-Print template at block 22. The created XHTML-Print data is then transmitted to an image forming device, such as a printer, via a transmission link (not shown) at block 24.

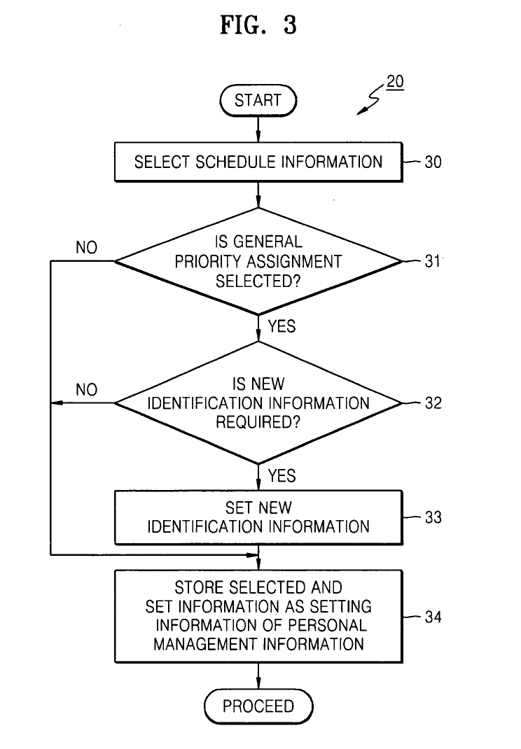

FIG. 3 is a flowchart illustrating a process of receiving setting information of personal management information at block 20, as shown in FIG. 2, according to an example embodiment of the present invention. Referring to FIG. 3, the schedule information is selected from among all the personal management information at block 30. Whether a general priority assignment is selected from the schedule information is determined at block 31. The general priority assignment may indicate that a high priority is simply assigned to a schedule having high significance. If the general priority assignment is not selected, the current process proceeds to block 34.

However, if the general priority assignment is selected, whether establishment of new identification information is required according to the general priority assignment is determined at block 32. The identification information according to priority assignment may indicate identification information set to discriminate a schedule having high significance from other schedules in the schedule chart. If the establishment of new identification information is not required, the current process proceeds to block 34.

However, if the establishment of new identification information is required, new identification information is set according to the general priority assignment at block 33. The selected and set information is stored as setting information of the personal management information at block 34. The stored setting information is then used to create the XHTML-Print data, as shown in FIG. 2.

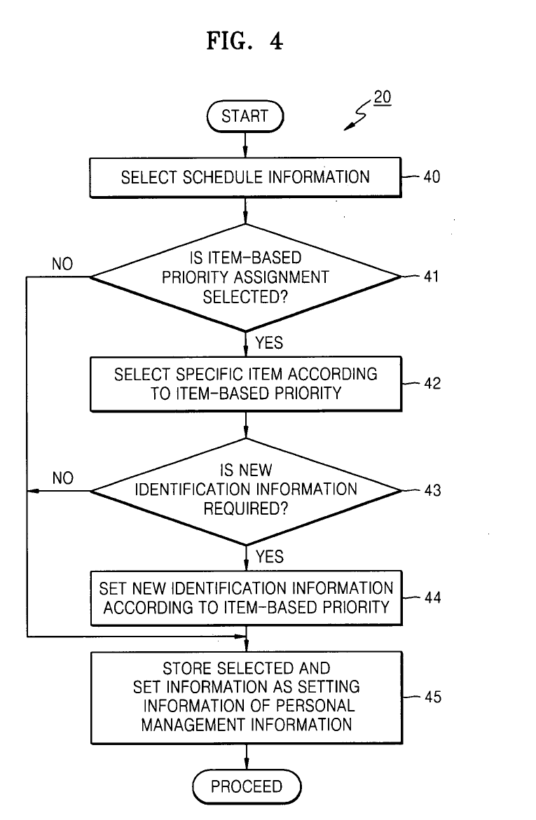

Turning now to FIG. 4, a flowchart a process of receiving setting information of personal management information at block 20, as shown in FIG. 2 according to another example embodiment of the present invention is shown. Referring to FIG. 4, the schedule information is selected from among the personal management information at block 40. At block 41, whether item-based priority assignment is selected from the schedule information is determined. The item-based priority assignment may indicate that priority is assigned according to schedule items. If the item-based priority assignment is not selected, the current process proceeds to block 45.

However, if the item-based priority assignment is selected, a specific item for the item-based priority is selected at block 42. At block 43, whether establishment of new identification information is required according to the item-based priority assignment is determined. The identification information according to priority assignment may indicate identification information set to discriminate a schedule having high significance from other schedules in the schedule chart. If the establishment of new identification information is not required, the current process proceeds to block 45.

However, if the establishment of new identification information is required, new identification information is set according to the item-based priority assignment at block 44. The selected and set information is stored as setting information of the personal management information at block 45. The stored setting information is then used to create the XHTML-Print data, as shown in FIG. 2.

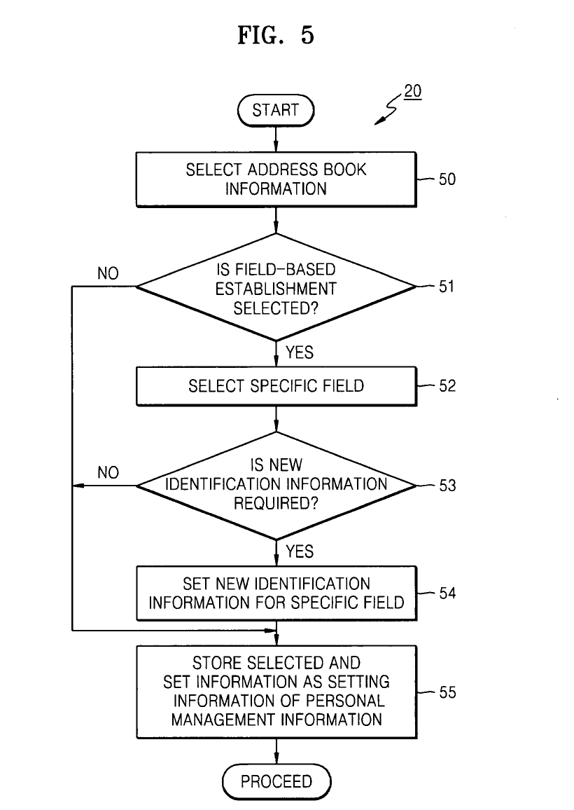

FIG. 5 is a flowchart illustrating a process of receiving setting information of personal management information at block 20, as shown in FIG. 2, according to yet another example embodiment of the present invention. Referring to FIG. 5, the address book information is selected from among the personal management information at block 50. At block 51, whether field-based establishment is selected from the address book information is determined. If the field-based establishment is not selected, the current process proceeds to block 55.

However, if the field-based establishment is selected, a specific field is selected at block 52. At block 53, whether establishment of new identification information is required according to the specific field is determined. If the establishment of new identification information is not required, the current process proceeds to block 55.

However, if the establishment of new identification information is required, new field-based identification information is set at block 54. The selected and set information is stored as setting information of the personal management information at block 55. The stored setting information is then used to create the XHTML-Print data, as shown in FIG. 2.

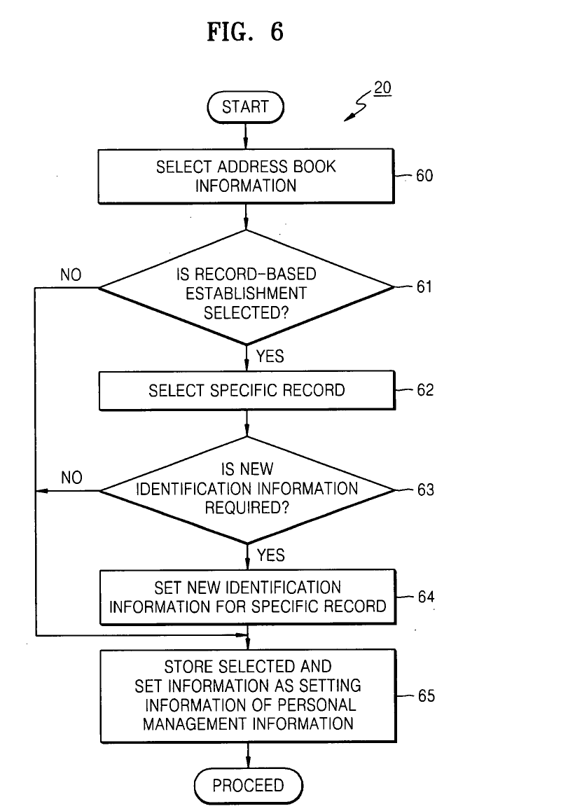

FIG. 6 is a flowchart illustrating a process of receiving setting information of personal management information at block 20, as shown in FIG. 2 according to yet another example embodiment of the present invention. Referring to FIG. 6, the address book information is selected among the personal management information at block 60. At block 61, whether record-based establishment is selected from the address book information is determined. If the record-based establishment is not selected, the current process proceeds to block 65.

However, if the record-based establishment is selected, a specific record is selected at block 62. At block 63, whether establishment of new identification information is required according to the specific record is determined. If the establishment of new identification information is not required, the current process proceeds to block 65.

However, if the establishment of new identification information is required, new record-based identification information is set at block 64. The selected and set information is stored as setting information of the personal management information at block 65. The stored setting information is then used to create the XHTML-Print data, as shown in FIG. 2.

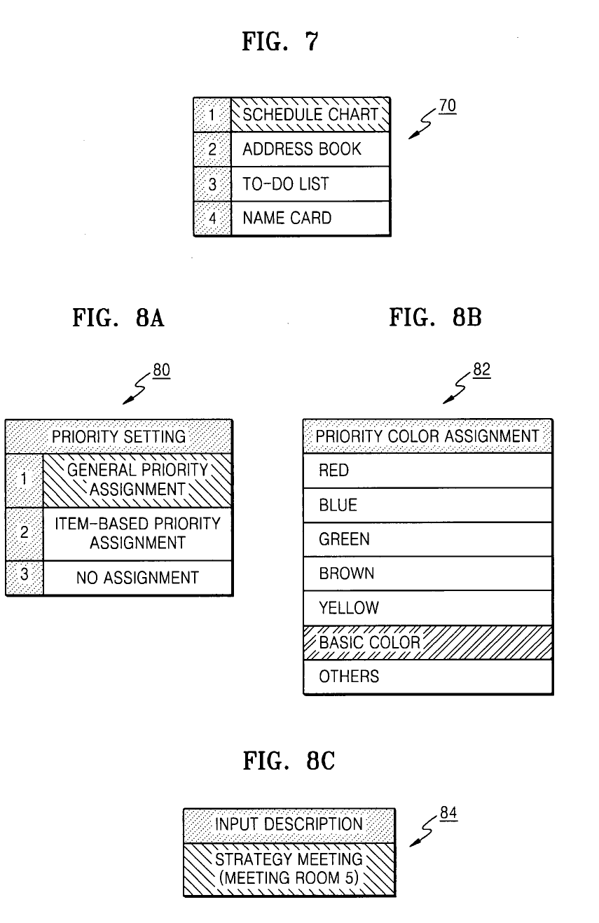

FIG. 7 illustrates an example dialog box for printing the personal management information according to an example embodiment of the present invention. As shown in FIG. 7, the dialog box 70 may include a schedule chart to contain schedule information, an address book to contain address book information, a to-do list to contain to-do list information, and a name card to contain name card information, all of which are included in the personal management information.

The schedule information includes date information, identification information according to priority assignment, and a schedule description input by a user. The date information indicates a date of each schedule, and the identification information according to priority assignment indicates identification information set to discriminate a schedule having high significance from other schedules. The identification information includes at least one of color, font type, font size, shadow, and underline. That is, by setting a schedule having a high priority differently from other schedules using color, font type, underline, and so on, when a schedule chart is displayed or printed, the schedule having a high priority can be easily recognized.

The priority assignment can be classified into the general priority assignment and the item-based priority assignment. The general priority assignment indicates that a high priority is simply assigned to a schedule having high significance, and the item-based priority assignment indicates that priority is assigned according to schedule items.

FIGS. 8A through 8C illustrate example dialog boxes for setting schedule information according to an example embodiment of the present invention. FIG. 8A illustrates an example dialog box 80 for priority assignment, FIG. 8B illustrates an example dialog box 82 for setting the identification information (e.g., color) according to priority assignment when the general priority assignment is selected in FIG. 8A, and FIG. 8C illustrates an example dialog box 84 for inputting a detailed description and date of a schedule. Although only information on color is shown in FIG. 8B, as identification information for discriminating a schedule having high significance from other schedules, identification information, such as font type, font size, shadow, and underline, can be used. In FIG. 8B, “basic value” is selected as the identification information. The basic value is identification information set by the user as a default value or previously set identification information. An “other” item of FIG. 8B is an item having information on a color except displayed colors. Through the dialog boxes shown in FIGS. 8A through 8C, the setting information of the schedule information among the personal management information can be set.

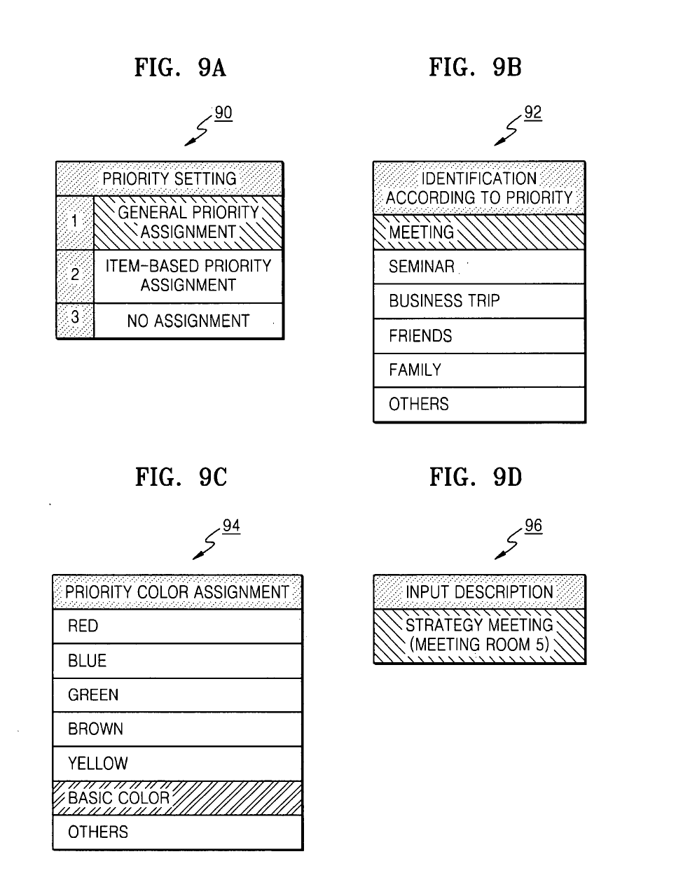

FIGS. 9A through 9D illustrate example dialog boxes for setting the schedule information according to another example embodiment of the present invention. FIG. 9A illustrates an example dialog box 90 for priority assignment, FIG. 9B illustrates an example dialog box 92 of an item-based classification list when the item-based priority assignment is selected in FIG. 9A, FIG. 9C illustrates an example dialog box 94 for setting identification information (e.g., color) of a selected classification item when an item is selected from the item-based classification list in FIG. 9B, and FIG. 9D illustrates an example dialog box 96 for inputting a detailed description and date of a schedule. Through the dialog boxes shown in FIGS. 9A through 9D, the setting information of the schedule information among the personal management information can be set.

The address book information includes field-based identification information of an address book, record-based identification information of the address book, and field and record-based identification information of the address book. The field-based identification information indicates identification information set to discriminate a specific category (e.g., name) from other categories when descriptions of the address book are classified according to categories, such as name, address, and telephone number. The record-based identification information indicates identification information set to discriminate address book information of a single person from address book information of other people in the descriptions of the address book. The field and record-based identification information indicates identification information set to discriminate specific information, e.g., only a telephone number of a specific person, from other address book information in the address book information.

The field-based identification information of the address book, record-based identification information of the address book, and field and record-based identification information of the address book can be set using at least one of color, font type, font size, shadow, and underline.

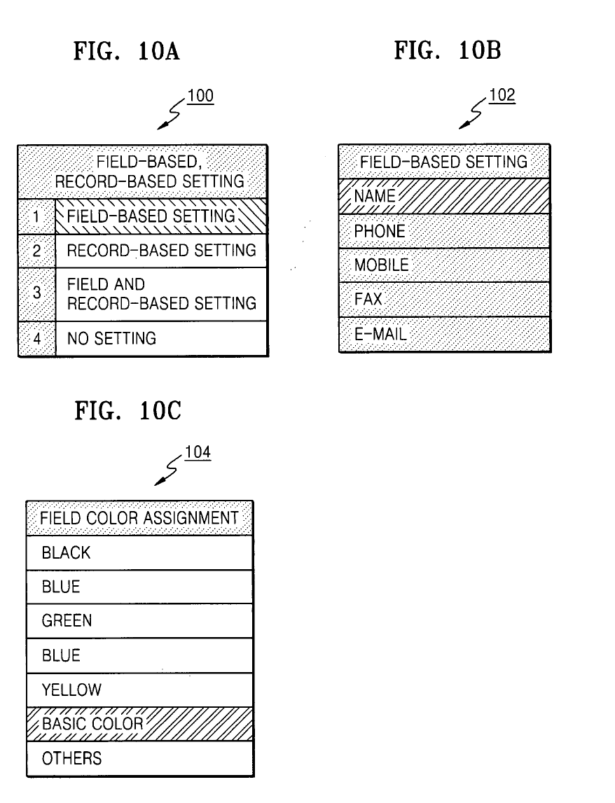

FIGS. 10A through 10C illustrate example dialog boxes for the address book information according to an example embodiment of the present invention. FIG. 10A illustrates an example dialog box 100 for setting the field-based identification information of the address book, record-based identification information of the address book, or field and record-based identification information of the address book, FIG. 10B illustrates an example dialog box 102 for setting one of the fields of the address book when the field-based identification information is selected in FIG. 10A, and FIG. 10C illustrates an example dialog box 104 for setting identification information (e.g., color) for a selected field. Although only information on color is shown in FIG. 10C, as identification information for discriminating a field of the address book from other fields, identification information, such as font type, font size, shadow, and underline, can also be used.

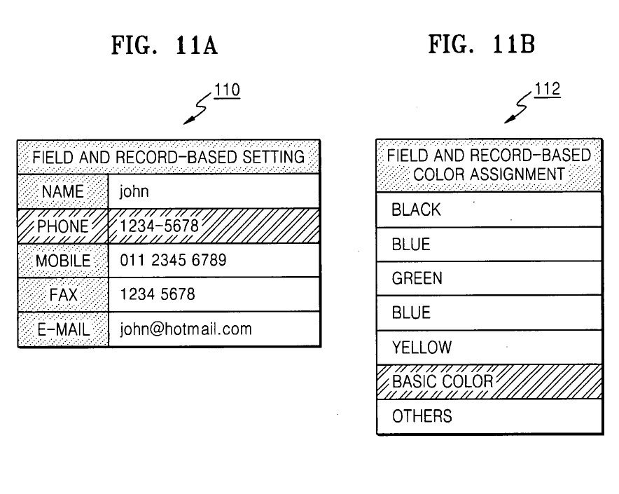

FIGS. 11A and 11B illustrate example dialog boxes for the address book information according to another example embodiment of the present invention. FIG. 11A illustrates an example dialog box 110 for setting specific address book information (e.g., telephone number) among address book information of a specific person when the field and record-based identification information is selected in FIG. 10A. FIG. 11B illustrates an example dialog box 112 for setting identification information (e.g., color) for discriminating the specific address book information from other address book information. Although only information on color is shown in FIG. 11B, as identification information, identification information, such as font type, font size, shadow, and underline, can be used.

Referring back to FIG. 2, an XHTML-Print template corresponding to the input setting information is detected, and XHTML-Print data in which the input setting information is reflected is created at block 22. XHTML-Print templates corresponding to respective setting information are previously stored. The XHTML-Print template corresponding to the input setting information is detected among the stored XHTML-Print templates. Setting information in the detected XHTML-Print template is replaced by the input setting information, and XHTML-Print data in which the input setting information is reflected is created.

In particular, in terms of the creation of the XHTML-Print data, the XHTML-Print data is created so that personal management information into which an image is inserted may be printed. To do this, information about images to be inserted is previously stored.

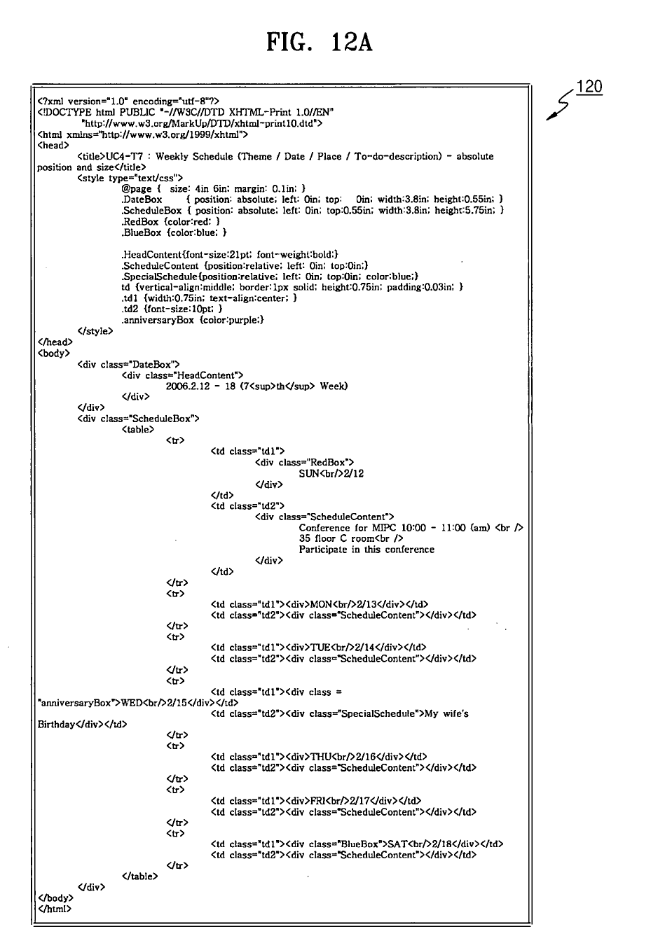

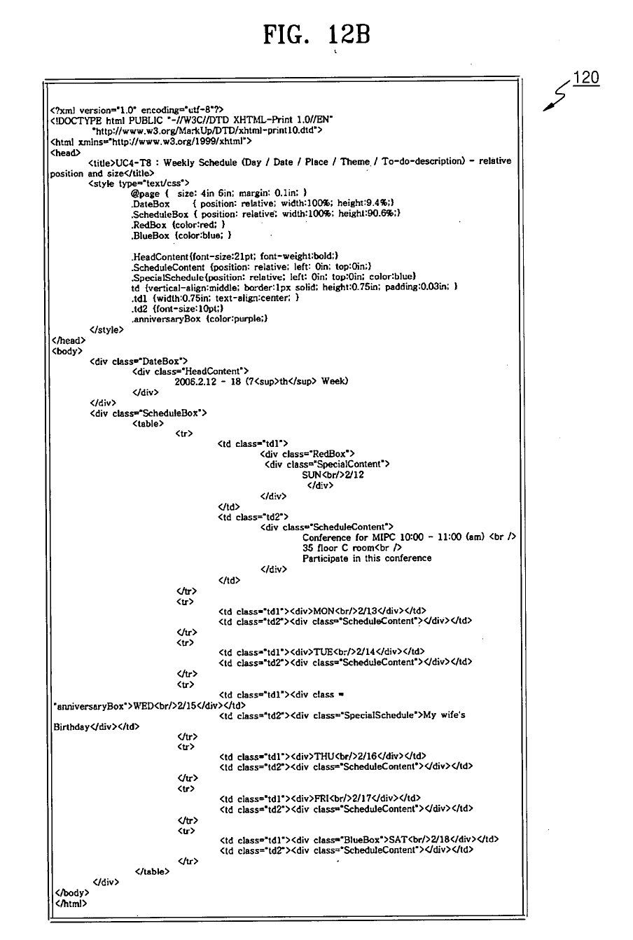

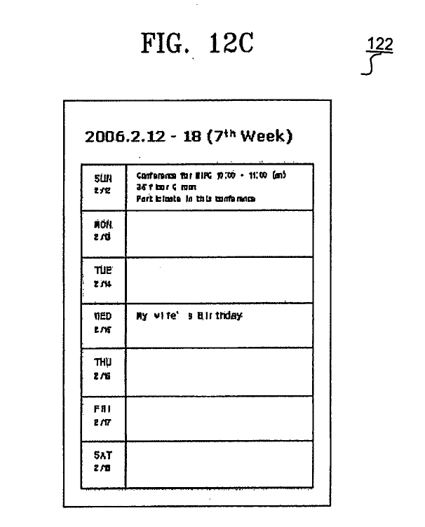

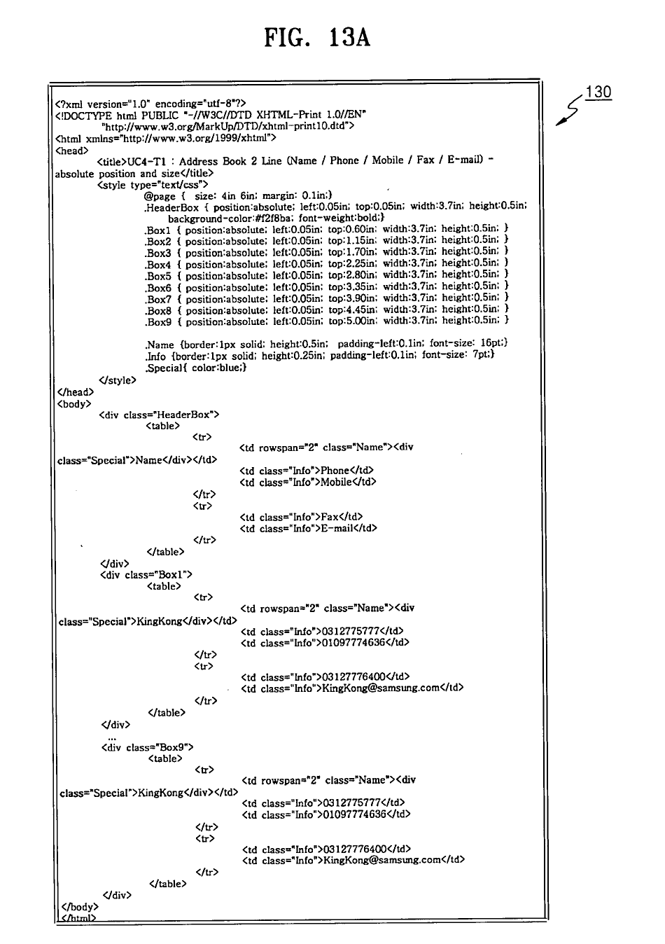

FIGS. 12A through 12C illustrate example XHTML-Print data created using detected XHTML-Print templates and a printed result thereof according to an example embodiment of the present invention. FIG. 12A illustrates example XHTML-Print data 120 created according to setting information of the schedule information among the personal management information. When the setting information is set to print a schedule of February 15^{th} with a blue color in order to discriminate the schedule from other schedules in a schedule chart, XHTML-Print data corresponding to this is created. Referring to FIG. 12A, a “blue” color is written as identification information in a portion corresponding to “SpecialSchedule” of a “head” part of the XHTML-Print data, and “My wife's Birthday” is written as anniversary information in a portion corresponding to “SpecialSchedule” of a “body” part of the XHTML-Print data 120.

FIG. 12B illustrates example XHTML-Print data 120 created using another XHTML-Print template. FIG. 12C illustrates a schedule chart 122 when the XHTML-Print data 120, shown in FIG. 12A or FIG. 12B, is analyzed and printed by an image forming device. In FIG. 12C, “My wife's Birthday” corresponding to a description of the anniversary is printed in blue according to “blue” written in the XHTML-Print data.

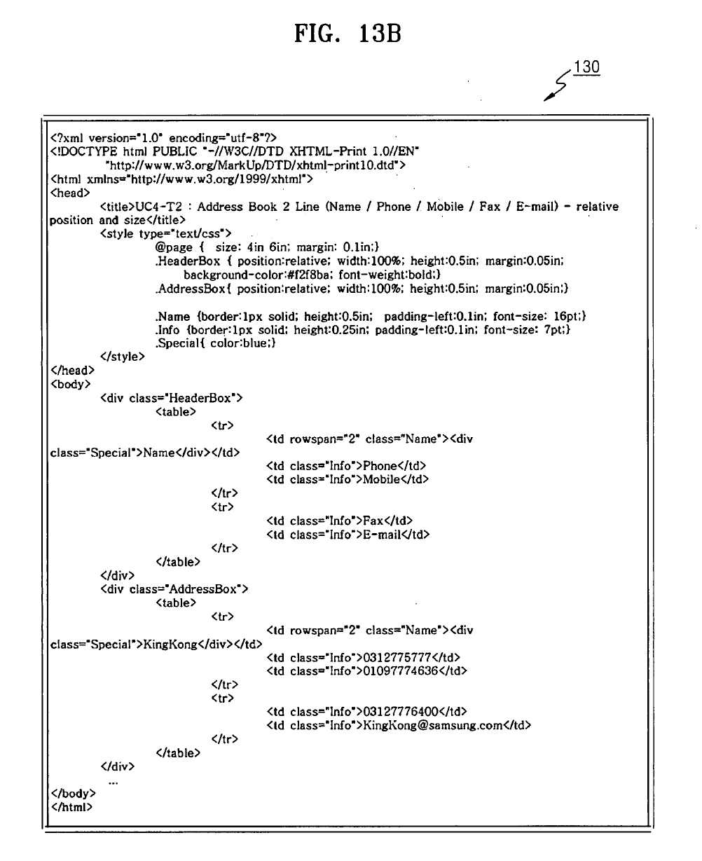

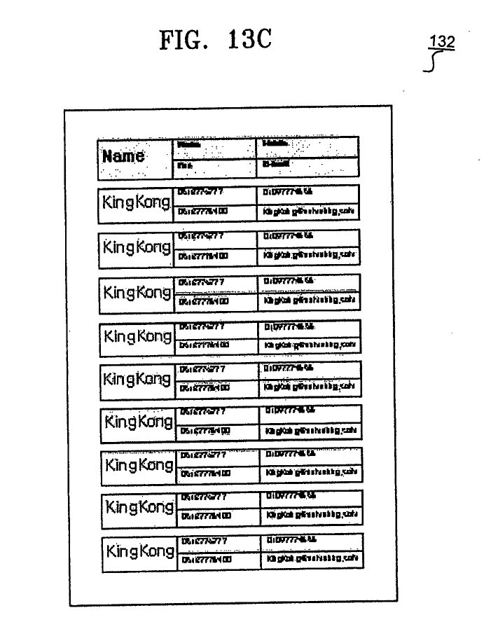

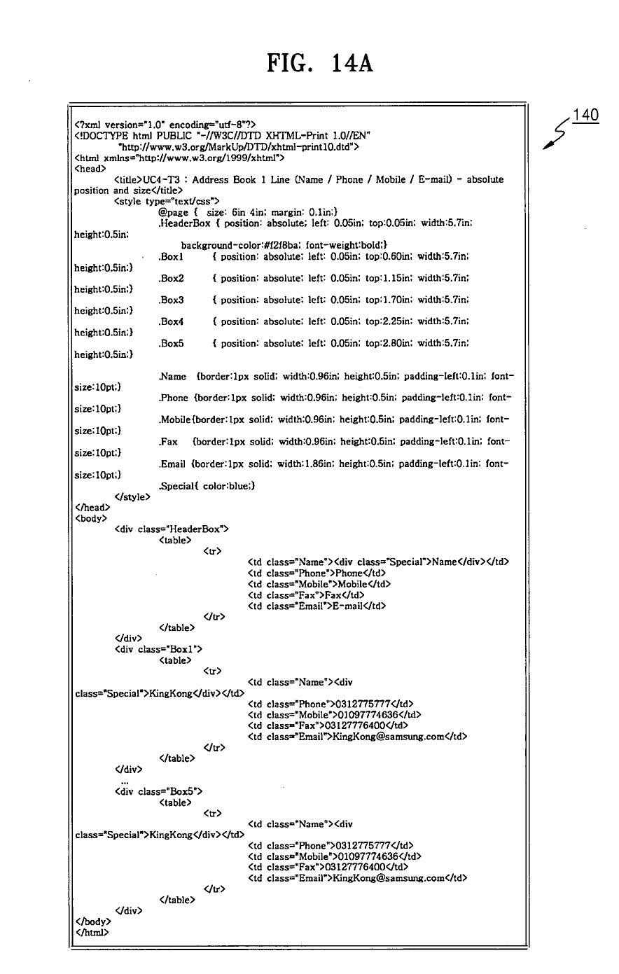

FIGS. 13A through 13C illustrate example XHTML-Print data created using detected XHTML-Print templates and a printed result thereof according to another example embodiment of the present invention. The detected XHTML-Print templates are templates to print the personal management information in a 4 inches×6 inches layout format. FIG. 13A illustrates example XHTML-Print data 130 created according to setting information set for the address book information of the personal management information to be identified by field. When “name” of the field-based identification information is set to be printed with the “blue” color, XHTML-Print data 130 corresponding to the field-based identification information is created. FIG. 13B illustrates example XHTML-Print data 130 created using another XHTML-Print template. FIG. 13C illustrates an example dialog box 132 for including address book information when the XHTML-Print data 130, as shown in FIG. 13A or FIG. 13B, is analyzed and printed by an image forming device. According to FIG. 13C, the user can easily recognize what names are managed in the address book information by printing “name” of the setting information with the “blue” color to discriminate a name field from other fields.

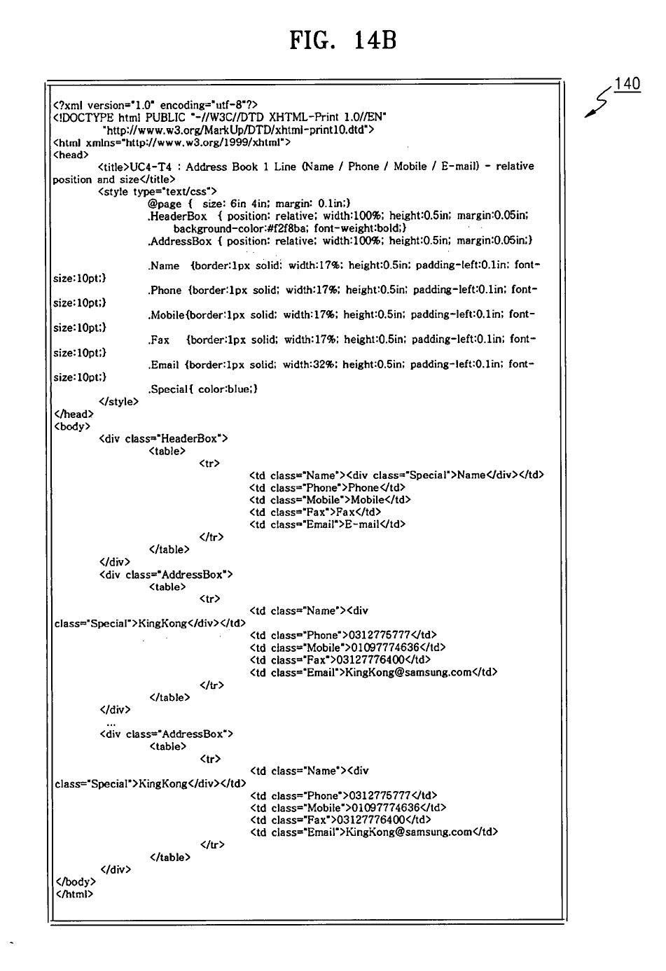

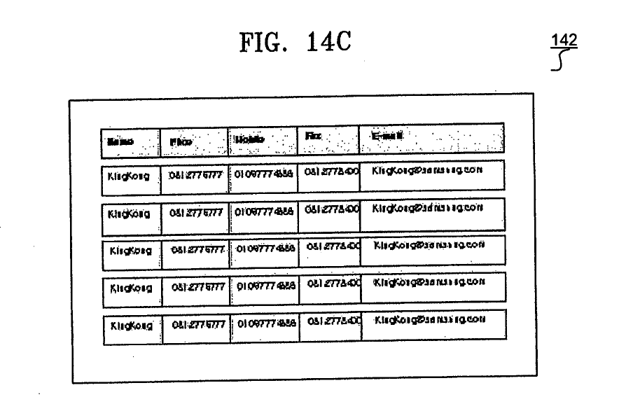

FIGS. 14A through 14C illustrate example XHTML-Print data created using detected XHTML-Print templates and a printed result thereof according to another example embodiment of the present invention. The detected XHTML-Print templates are templates to print the personal management information in a 6 inches×4 inches layout format. FIG. 14A illustrates example XHTML-Print data 140 created according to setting information set for the address book information of the personal management information to be identified by field. FIG. 14B illustrates example XHTML-Print data 140 created using another XHTML-Print template. FIG. 14C illustrates an example dialog box 142 for including address book information when the XHTML-Print data 140, as shown in FIG. 14A or FIG. 14B, is analyzed and printed by an image forming device. Since FIGS. 14A through 14C are almost the same as FIGS. 13A through 13C, a detailed description of FIGS. 14A through 14C is omitted for brevity.

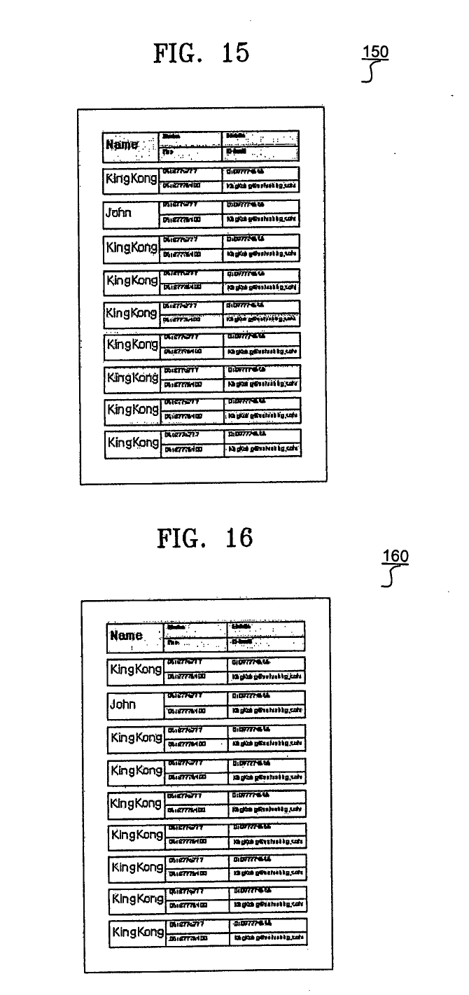

FIG. 15 illustrates personal management information printed by analyzing XHTML-Print data according to another example embodiment of the present invention. FIG. 15 shows an example print result 150 printed by analyzing XHTML-Print data created according to setting information set for address book information of the personal management information to be identified by record. For example, by printing address book information of an object “John”, i.e., information such as address, home telephone number, mobile phone number, and e-mail address, with the blue color to discriminate the address book information from address book information of other records, the user can easily recognize information on a specific person in the address book information as compared to information on other people.

FIG. 16 illustrates personal management information printed by analyzing XHTML-Print data according to another example embodiment of the present invention. FIG. 16 shows an example print result 160 printed by analyzing XHTML-Print data created to discriminate specific information of a specific record of address book information from address book information of other records. For example, by printing only an email address of address book information of a record “John” with the blue color to discriminate the email address from address book information of other records, the user can easily recognize specific information of a specific record in the address book information as compared to other records.

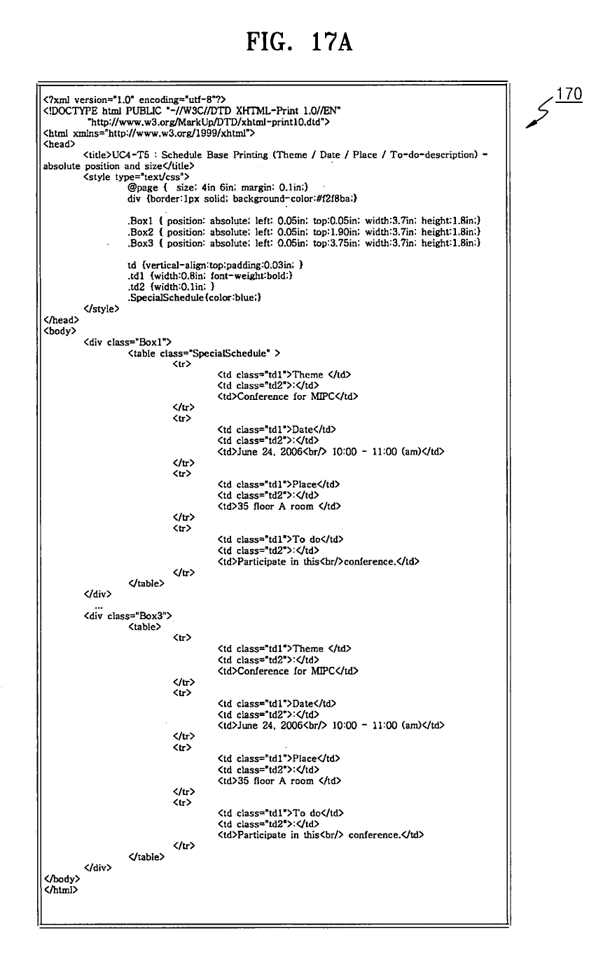

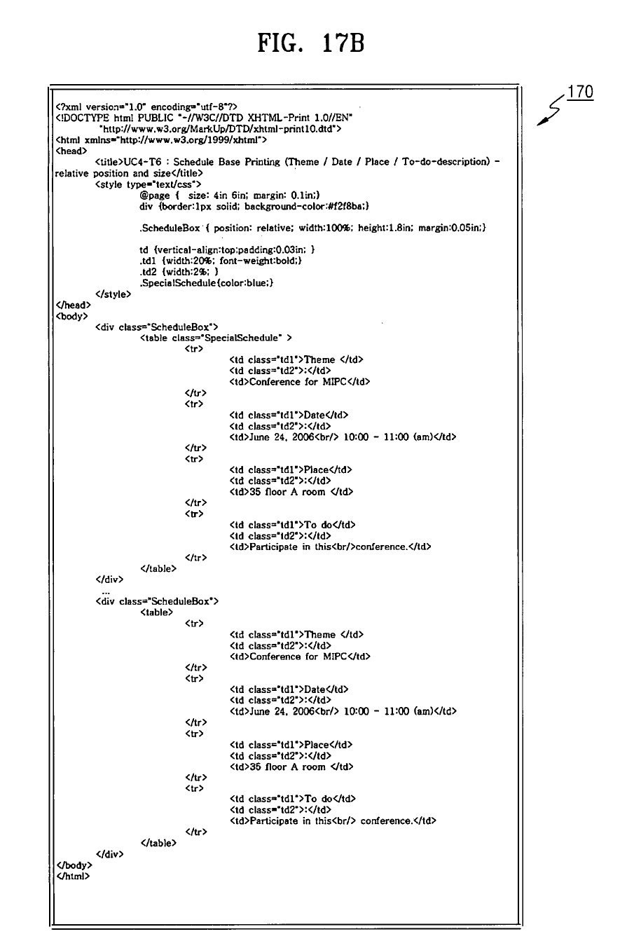

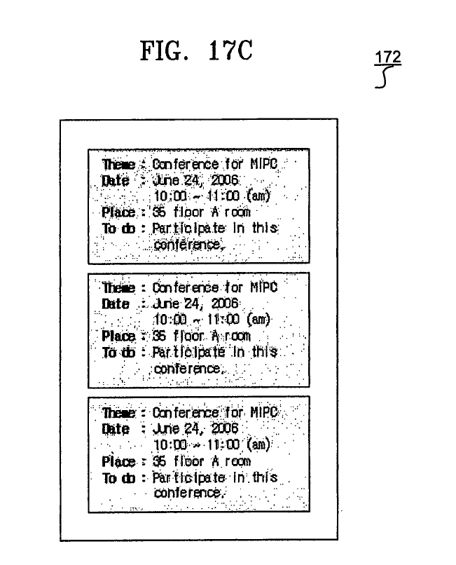

FIGS. 17A through 17C illustrate example XHTML-Print data created using detected XHTML-Print templates and a printed result thereof according to another example embodiment of the present invention. FIG. 17A illustrates example XHTML-Print data 170 created to print to-do list information of the personal management information, FIG. 17B illustrates example XHTML-Print data 170 created using another XHTML-Print template, and FIG. 17C illustrates an example dialog box 172 containing to-do list information when the XHTML-Print data 170, shown in FIG. 17A or FIG. 17B, is analyzed and printed by an image forming device. According to FIG. 17C, the user can easily recognize a task to be first dealt with by checking a to-do list printed with the “blue” color.

Referring back to FIG. 2, the created XHTML-Print data is transmitted to an image forming device, such as a printer, via a transmission link, at block 24. That is, the created XHTML-Print data is transmitted to the image forming device which is connected to the mobile device through a network.

Referring back to FIG. 1, the image forming device, such as a printer, prints the personal management information by analyzing the transmitted XHTML-Print data at block 12. In other words, the image forming device receives the XHTML-Print data of the personal management information from the mobile device, via the transmission link, analyzes the received XHTML-Print data, and prints the analysis result using a print engine.

The embodiments of the present invention can be written as codes/instructions/programs and can be implemented in general-use digital computers that execute the codes/instructions/programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

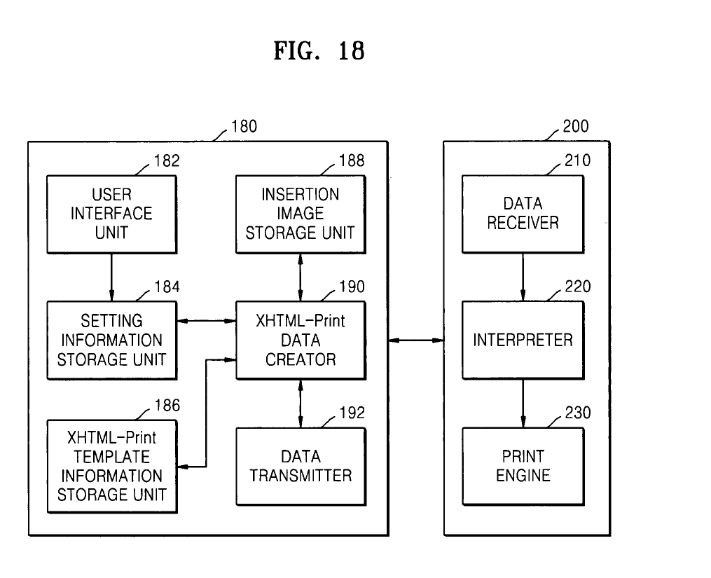

FIG. 18 is a block diagram of a system for printing personal management information using a device according to an embodiment of the present invention. Referring to FIG. 18, the system includes a mobile device 180 and an image forming device 200.

The mobile device 180 creates XHTML-Print data of personal management information using an XHTML-Print template defining a layout for printing the personal management information and outputs the created XHTML-Print data to the image forming device 200, via a transmission link.

To create the XHTML-Print data of the personal management information, the mobile device 180 includes a user interface unit 182, a setting information storage unit 184, an XHTML-Print template information storage unit 186, an insertion image storage unit 188, an XHTML-Print data creator 190, and a data transmitter 192.

The user interface unit 182 allows a user to input setting information of the personal management information. The user interface unit 182 displays dialog boxes, like those shown in FIGS. 7 through 11, and allows the user to input setting information of the personal management information through the displayed dialog boxes.

The personal management information includes at least one of schedule information, address book information, to-do list information, and name card information. Stored schedule information includes date information, identification information according to priority assignment, and descriptions input by the user. The priority assignment is performed according to general priority or priority classified for items. The identification information includes at least one of color, font type, font size, shadow, and underline. Stored address book information includes field-based identification information of an address book, record-based identification information of the address book, and field and record-based identification information of the address book. The field-based identification information of the address book, the record-based identification information of the address book, and the field and record-based identification information of the address book include at least one of color, font type, font size, shadow, and underline. Since a detailed description of the personal management information is the same as that of the above-described method, the detailed description is omitted hereinafter.

The setting information storage unit 184 stores the setting information input from the user interface unit 182 and outputs the stored setting information to the XHTML-Print data creator 190 in response to a request by the XHTML-Print data creator 190.

The XHTML-Print template information storage unit 186 stores XHTML-Print templates corresponding to various layouts of the personal management information. The XHTML-Print template information storage unit 186 transmits an XHTML-Print template corresponding to the setting information to the XHTML-Print data creator 190 in response to a request by the XHTML-Print data creator 190.

The insertion image storage unit 188 stores various images to be inserted into the personal management information and transmits an image to be inserted into the personal management information to the XHTML-Print data creator 190 in response to a request of the XHTML-Print data creator 190.

The XHTML-Print data creator 190 detects an XHTML-Print template corresponding to the setting information stored in the setting information storage unit 184 from the XHTML-Print template information storage unit 186 and creates XHTML-Print data by reflecting the setting information in the detected XHTML-Print template. The created XHTML-Print data is output to the data transmitter 192. The XHTML-Print data creator 190 detects an image to be inserted into the personal management information from the images stored in the insertion image storage unit 188 and creates XHTML-Print data including the detected insertion image to be printed.

The data transmitter 192 transmits the created XHTML-Print data to the image forming device 200, via a transmission link. Such a transmission link may utilize existing and accepted connectivity standards, including, for example: Bluetooth, IrDA and Wi-Fi for a wireless solution; PictBridge as a wired solution; and printing directly from memory cards.

The image forming device 200 prints the personal management information by analyzing the XHTML-Print data transmitted from the mobile device 180. To do this, the image forming device 200 includes a data receiver 210, an interpreter 220, and a print engine 230.

The data receiver 210 receives the XHTML-Print data transmitted from the device 100 and outputs the received XHTML-Print data to the interpreter 220. The interpreter 220 analyzes the received XHTML-Print data and outputs the analysis result to the print engine 230. The print engine 230 prints the analyzed XHTML-Print data.

As described above, a method and system for printing personal management information according to the present invention allows a user to easily edit and print the personal management information using a markup language, such as XHTML-Print data, in order to designate a style. That is, the user can print the personal management information to recognize a specific item of the personal management information more easily than other items by classifying the personal management information, such as schedule information, address book information, to-do list information, and name card information, according to priority or on a field basis.

Various components of the mobile device 180 and the image forming device 200, as shown in FIG. 18, can be integrated into a single control unit, or alternatively, can be implemented in software or hardware, such as, for example, an application specific integrated circuit (ASIC). For example, the setting information storage unit 184, the XHTML-Print template information storage unit 186, the insert image storage unit 188 of the mobile device 180 can be implemented by a single storage unit. The XHTML-Print data creator can be integrated into a single control unit, or alternatively, implemented as functions of an operating system (OS) of the mobile device 190. Similarly, the interpreter 220 can be integrated into an operating system (OS) of the image forming device 200. As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media. Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A method of printing personal management information, the method comprising:
creating, at a mobile device, extensible hyper text markup language (XHTML)-data of personal management information using an XHTML-template defining a layout for printing the personal management information, and transmitting the created XHTML-data to an image forming device; and
analyzing, at the image forming device, the transmitted XHTML-data and printing the personal management information.

2. The method of claim 1, further comprising:
receiving setting information of the personal management information; and
selecting an XHTML-template corresponding to the received setting information and creating XHTML-data on which the received setting information is reflected before transmitting the created XHTML-data to the image forming device, via a transmission link.

3. The method of claim 2, wherein the personal management information comprises at least one of schedule information, address book information, to-do list information, and name card information.

4. The method of claim 3, wherein the schedule information comprises date information, identification information according to priority assignment, and schedule description input by a user.

5. The method of claim 4, wherein the identification information comprises at least one of color, font type, font size, shadow, and underline.

6. The method of claim 4, further comprising:
selecting the schedule information among the personal management information;
determining whether general priority assignment is selected in the selected schedule information;
when the general priority assignment has been selected, determining whether establishment of new identification information according to the general priority assignment is required;
when establishment of new identification information is required, setting new identification information according to the general priority assignment; and
storing the selected and set information as setting information of the personal management information.

7. The method of claim 4, further comprising:
selecting the schedule information among the personal management information;
determining whether item-based priority assignment is selected from the selected schedule information;
when the item-based priority assignment has been selected, selecting a specific item according to item-based priority;
determining whether establishment of new identification information according to the item-based priority assignment is required;
when establishment of new identification information is required, setting new identification information according to the item-based priority assignment; and
storing the selected and set information as setting information of the personal management information.

8. The method of claim 3, wherein the address book information comprises field-based identification information of an address book, record-based identification information of the address book, and field and record-based identification information of the address book.

9. The method of claim 8, wherein the field-based identification information of the address book, the record-based identification information of the address book, and the field and record-based identification information of the address book comprise at least one of color, font type, font size, shadow, and underline.

10. The method of claim 8, further comprising:
selecting the address book information among the personal management information;
determining whether field-based establishment is selected from the selected address book information;
when the field-based establishment has been selected, selecting a specific field;
determining whether establishment of new identification information according to the specific field is required;
when establishment of new identification information is required, setting identification information of the specific field; and
storing the selected and set information as setting information of the personal management information.

11. The method of claim 8, further comprising:
selecting the address book information among the personal management information;
determining whether record-based establishment is selected from the selected address book information;
when the record-based establishment has been selected, selecting a specific record;
determining whether establishment of new identification information according to the specific record is required;
when establishment of new identification information is required, setting identification information of the specific record; and
storing the selected and set information as setting information of the personal management information.

12. The method of claim 2, wherein the XHTML-data is created to print the personal management information into which an image is inserted or to print the image with name card information.

13. A computer readable recording medium storing a computer readable program for executing the method of claim 1.

14. A system for printing personal management information, the system comprising:
an electronic device arranged to create extensible hyper text markup language (XHTML)-data of personal management information using an XHTML-template defining a layout for printing the personal management information, and to transmit the XHTML-data, via a transmission link; and
an image forming device arranged to receive the XHTML-data transmitted from the electronic device, via the transmission link, and to print the personal management information.

15. The system of claim 14, wherein the electronic device comprises:
an XHTML-template information storage unit to store XHTML-template information corresponding to various layouts of the personal management information;
a user interface unit arranged to enable a user to input setting information of the personal management information;
a setting information storage unit to store the setting information input by the user;
an XHTML-data creator arranged to detect an XHTML-template corresponding to the stored setting information and to create XHTML-data on which the input setting information is reflected; and
a data transmitter arranged to transmit the created XHTML-data to the image forming device, via a transmission link.

16. The system of claim 15, wherein the personal management information comprises at least one of schedule information, address book information, to-do list information, and name card information.

17. The system of claim 14, wherein the schedule information comprises date information, identification information according to priority assignment, and schedule description input by the user, and the identification information comprises at least one of color, font type, font size, shadow, and underline.

18. The system of claim 16, wherein the address book information comprises field-based identification information of an address book, record-based identification information of the address book, and field and record-based identification information of the address book, and the field-based identification information of the address book, the record-based identification information of the address book, and the field and record-based identification information of the address book comprise at least one of color, font type, font size, shadow, and underline.

19. The system of claim 15, further comprising:
an insertion image storage unit arranged to store various images to be inserted into the personal management information,
wherein the XHTML-data creator creates the XHTML-data to print the personal management information into which an image stored in the insertion image storage unit is inserted.

20. The system of claim 14, wherein the image forming device comprises:
an interpreter arrange to analyze the XHTML-data transmitted from the electronic device; and
a print engine arranged to print the analyzed XHTML-data.

21. A mobile device for generating personal management information comprising:
a user interface unit arranged to receive setting information of the personal management information input from a user;
a storage unit arranged to store XHTML-template information corresponding to various layouts of the personal management information, to store the setting information input by the user; and
a control unit arranged to detect an XHTML-template corresponding to the setting information, to create XHTML-data on which the input setting information is reflected, and to transmit created XHTML-data, via a transmission link.

22. The mobile device of claim 21, wherein the personal management information comprises at least one of schedule information, address book information, to-do list information, and name card information.

23. The mobile device of claim 22, wherein the schedule information comprises date information, identification information according to priority assignment, and schedule description input by the user, and the identification information comprises at least one of color, font type, font size, shadow, and underline.

24. The mobile device of claim 22, wherein the address book information comprises field-based identification information of an address book, record-based identification information of the address book, and field and record-based identification information of the address book, and the field-based identification information of the address book, the record-based identification information of the address book, and the field and record-based identification information of the address book comprise at least one of color, font type, font size, shadow, and underline.

25. The mobile device of claim 22, wherein the storage unit further store various images to be inserted into the personal management information, and wherein the control unit creates the XHTML-data to print the personal management information into which an image is inserted therein.

26. The mobile system of claim 22, wherein XHTML-data is transmitted to an image forming device, via the transmission link, to be printed at the image forming device, and wherein the image forming device comprises an interpreter arrange to analyze the XHTML-data transmitted from the electronic device, and a print engine arranged to print the analyzed XHTML-data.
